(19) United States
(12) Patent Application Publication
(10) Pub. No.: US 2023/0124238 A1
(43) Pub. Date: Apr. 20, 2023

(54) REMOTE TOWER ASSET MONITORING SYSTEM (RTAMS)

(71) Applicant: OMNIPRESENT GLOBAL (PTY) LTD, JOHANNESBURG (ZA)

(72) Inventor: APHIWE ADAMS, JOHANNESBURG (ZA)

(21) Appl. No.: 17/908,143

(22) PCT Filed: Mar. 24, 2021
(86) PCT No.: PCT/IB2021/052425

§ 371 Date: Aug. 30, 2022

(30) Foreign Application Priority Data
Mar. 24, 2020 (ZA) 2020/01852

(51) Int. Cl. G06V 20/52; G06V 10/82; G06V 10/94; G08B 21/18

(52) U.S. Cl. CPC G06V 20/52; G06V 10/82; G06V 10/94; G08B 21/18

(57) ABSTRACT

The present invention relates to remote monitoring system for detecting changes to equipment installed in a structure and/or structure site and generating an alert message describing said changes. The system includes a sensing arrangement; an electronic database; a data transmission means; a method of identifying physical and visual changes to an object, wherein the method utilizes a first set of visual data of an object, followed by receiving a second set of visual data of the object, and comparing the first and second set of visual data to identify visual and physical changes to the object. This system therefore serves to identify changes to equipment that has been added, misaligned, moved or stolen, and then notifying a user of said changes by the transmission of an alert message.

### FIELD OF APPLICATION OF THE INVENTION

The present invention relates to remote monitoring system for detecting changes to equipment installed in a structure and generating an alert message describing said changes autonomously.

### BACKGROUND TO THE INVENTION

The ubiquitous influence of technology has resulted in various modes of communications that often involve the transfer of data as opposed to the use of spoken word. The increasing digitisation of modes of communications has required a significant investment in the telecommunications sector; a sector that makes use of large cellular base stations (cell tower) to allow for communication on a global scale, including the transfer of data in either text, voice, audio or video format. Each cell tower is fit with antennas and electronic communications equipment to generate a cellular network. Often, each cell tower has the capacity for a set number of antennas that are aligned for optimal performance, with each antenna adjustable for both altitude (vertical plane adjustment) and azimuth (horizontal plane adjustment). The antennas are typically also grouped in arrays or patterns that are configured for optimal performance. As such, the owner of a cell tower leases out the antennae space to multiple cellular providers.

Sharing the available antenna space to different cellular providers is possible as separate systems often use different frequencies, such that interference can be avoided. However, the installation of antennae and other electronic communications equipment often results in some cellular providers damaging the equipment of other neighbouring leasing parties' cellular providers. The removal and installation of hardware often results in the regular theft of equipment by third parties that have somehow accessed the premises, but also occasionally by other cellular providers. Furthermore, unauthorized installation of antennae and other electronic equipment may lead to structural damage due to overloading.

To alleviate the problem of equipment damage theft, and potential structural overloading some cellular providers perform regular site audits to inspect the area leased to each cellular provider. While the purpose of these site audits is to identify irregular installation, damage to property and missing equipment, it is often difficult to ascertain which party is responsible for the irregular installation, removal or damaging of cell tower equipment.

Previously, cell tower antenna alignment was regularly evaluated by skilled technicians to ensure that the alignment is suitable for optimal performance. This proved to be a very expensive exercise, and in many cases hazardous, as the skilled technicians were required to ascend the tower with sophisticated equipment and align each individual antenna.

U.S. Pat. No. 8,184,050 B2 discloses a system using global navigation satellite system (GNSS) antennas for triangulating, aligning and monitoring the antennas that are used to transmit and receive signals used in a cellular network. The disadvantage of this invention is that while it does involve the continuous monitoring of antenna alignment, the system is incapable of identifying third parties that have either misaligned the antennas or stolen them. In short, this invention only monitors the position of each antenna, but does not provide a clear description of the environment that might have resulted in such a misalignment. In addition, the system of GNSS antennas will also require skilled and expensive technicians to service or fix the GNSS equipment that malfunctions.

US 2007/0229378 A1 discloses a system whereby data related to the latitude, longitude, orientation and tilt of each antenna and relayed to a remote data station. These requires the installation of a Global Positioning System (GPS) measuring device, noted to include a GPS antenna, and is used to measure the latitude, longitude and elevation of an antenna. The tilt of the antenna is then typically measured by installing an additional magnetic compass module. Finally, a camera is used to detect large, nearby objects. However, the data stored for each of these parameters will then have to be manually assessed by personnel and compared to previous data so as to verify the position of each antenna.

US 2017/0094229 A1 discloses a method for monitoring the communication equipment and more specifically, the cables that are installed on a structure. The information related to the installation of each cable is electronically stored and then transferred to a computer, where the computer is able to compare past and current information so as to ascertain whether there have any unauthorized cables installed on the structure. While this patent application can monitor some changes to the installation of equipment in real-time, it does not allow a user to identify any third parties that have misaligned, damaged, stolen or installation of additional equipment on the structure.

Given the above, it is clear that there is a need for a remote monitoring system that is capable of identifying when an individual or external force has misaligned, damaged or stolen the equipment installed on a structure and/or conducted unauthorised equipment installations. Furthermore, an automated system that has been configured to notify a user when any changes to a specific piece of equipment is detected, will not only save costs, but also limit the need of skilled technicians that often have to perform site audits and often be required to service each piece of equipment individually.

### OBJECT OF THE INVENTION

It is accordingly an object of the present invention to provide a remote monitoring system that seeks to, at least partially, overcome or lessen the above disadvantages and/or will be a useful alternative to existing monitoring systems.

### SUMMARY OF THE INVENTION

According to a first aspect thereof, there is provided a remote monitoring system, the system including:
a sensing arrangement for capturing visual data of an object;
an electronic database for the storage of visual data;
a data transmission means for transmitting the visual data from the sensing arrangement to the electronic database; and
a method to identify physical and visual changes to the object,
   wherein the method may include the steps of receiving a first set of visual data of one or more objects, followed by receiving a second set of visual data of the one or more objects, and comparing the first and second set of visual data to identify visual and physical changes to the one or more objects.

The object may be, but is not limited to, an antenna, microwave dish and/or a base station.

The sensing arrangement may include at least one camera.

It will be appreciated to the person skilled in the art that a suitable camera may be used in terms of the present invention.

The electronic database may be hosted and accessed on one or more computers or may be hosted and accessed on a network.

The electronic database may be stored on a virtual machine.

The electronic database may be accessed remotely with a computer.

The data transmission means may include, but is not limited to Bluetooth, radio waves, microwaves, fibre optical cables, local area network and/or wide area network.

In one embodiment, the visual data may be transmitted by the data transmission means to a specialized computer and then transmitted by the data transmission means to the electronic database.

It will be appreciated to the person skilled in the art that the specialized computer may be a Kentrox unit produced by Westell Technologies and used in terms of the present invention.

The specialized computer may be an intelligent remote site management device.

The specialized computer may be a channel service unit or a data service unit.

The specialized computer may be an edge server.

The method may be stored on the electronic database as an artificial neural network to learn how to identify differences between sets of visual data.

In an embodiment of the invention, it will be appreciated to a person skilled in the art that the detectron2, PyTorch or similar software may be used as the artificial neural network in terms of the present invention.

The electronic database may generate a unique alert notification when any differences are detected between sets of visual data.

The unique alert notification may be an email.

The unique alert notification may be transmitted to a remote computer by the data transmission means and contain a site code of the site where the object in question is geographically situated.

The unique alert notification may be an alert message.

The remote monitoring system may be powered by batteries.

The remote monitoring system may be powered by solar panels.

According to a second aspect of the invention, there is provided for the use of a remote monitoring system, substantially as herein described and exemplified.

According to a third aspect of the invention, there is provided for use of the unique alert notification for identifying changes to one or more objects.

According to a fourth aspect of the invention, there is provided for use of the unique alert notification to oversee changes made to one or more objects.

The above and other characteristics, features and advantages of the present invention will become apparent from the following detailed description, taken in conjunction with the accompanying drawing which illustrate, by way of example, the principles of the invention. This description is given for the sake of example only, without limiting the scope of the invention. The reference figures quoted below refer to the attached drawings.

### BRIEF DESCRIPTION OF THE DRAWINGS

Preferred embodiments of the invention are described below with reference to the accompanying figures, wherein:

FIG. 1 is a broad illustration of the hardware and software components that are utilized in the remote monitoring system; and

FIG. 2 is illustrating how a unique alert notification is generated for changes made to the antenna of a cell phone tower.

The presently disclosed subject matter will now be described more fully hereinafter with reference to the accompanying example, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

### DETAILED DESCRIPTION OF THE INVENTION

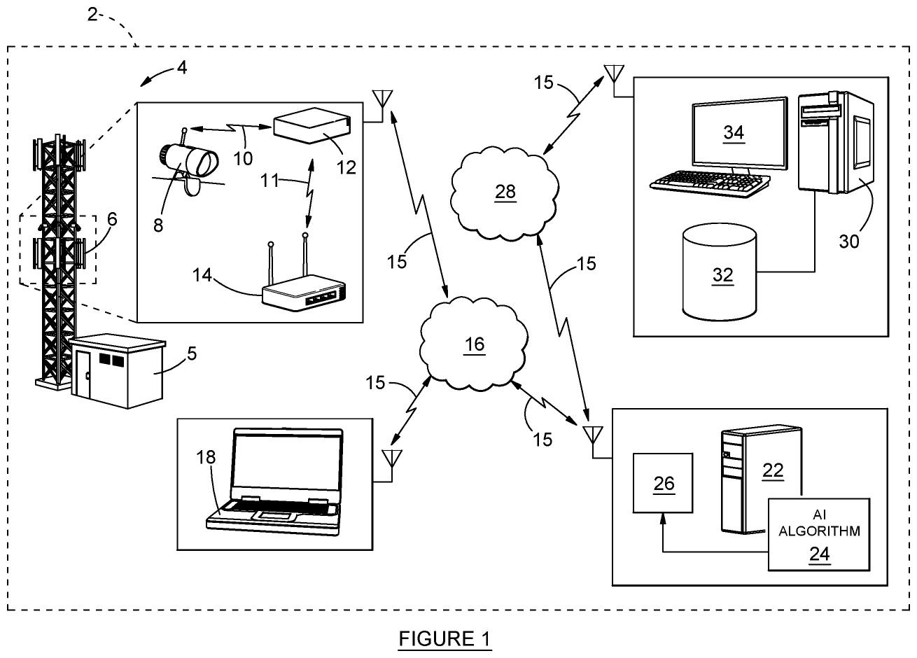

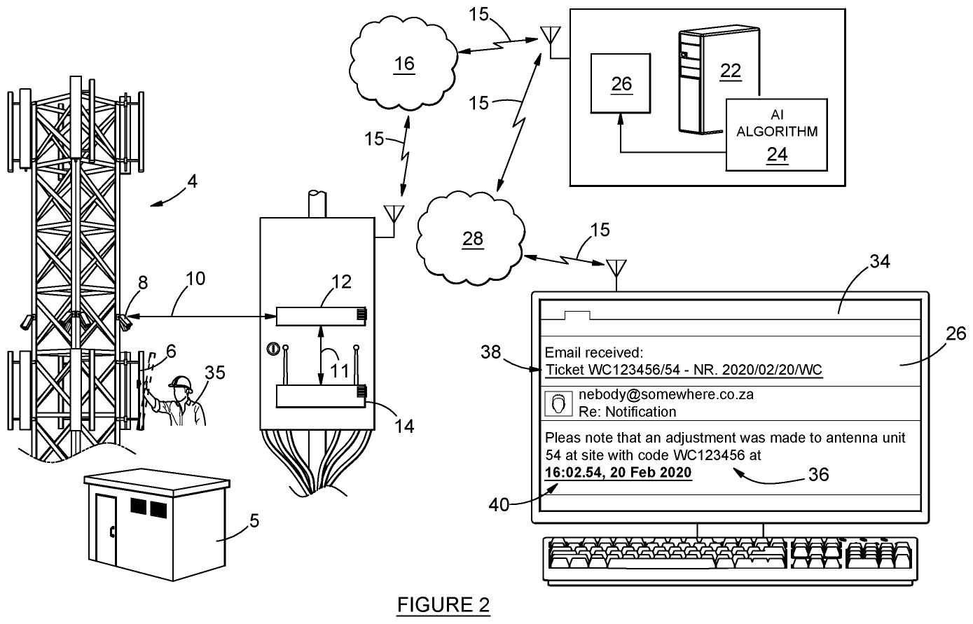

A non-limiting example of a preferred embodiment of the invention is described in more detail below, with reference to FIGS. 1 to 2.

With reference to FIG. 1, there is provided a remote monitoring system 2 for detecting changes to equipment that is typically installed on a cell phone tower 4 and a base station 5. An antenna 6 and a camera 8 is installed on the cell phone tower 4. The camera 8 is used to monitor the base station 5, antenna 6 or another object (not shown) on the cell phone tower, and where the camera 8 captures an image of the base station 5, antenna 6 or another object (not shown) at regular intervals. The visual data related to the captured images is transferred via optic fibre cables 10 to an edge server 12, which is a device that stores data close to the source in order to transfer it more effectively at any stage. The edge server 12 contains artificial neural network (ANN) software 24 used to analyse visual data that has been received from the camera 8 via optic fibre cables 10.

The visual data can then be transferred via ethernet cables 11 to a specialized computer 14, which is a channel service unit or data service unit such as a Kentrox Device, and is capable of transferring large quantities of stored visual data via radio waves 15 to the intranet network 16. In addition, a developer computer 18 can be used to access the visual data on the intranet network 16 by remote access and using radio waves 15.

The visual data stored on the intranet network 16 is transferred via radio waves 15 to a host virtual machine 22. The host virtual machine 22 contains artificial neural network (ANN) software 24 used to analyse the visual data that has been received from the intranet network 16. More specifically, the embodiment utilizes a combination of ANN software 24 that has been developed by the Facebook AI Research lab, namely detectron2 and PyTorch. These software packages were selected due to their recognition as being the leading object detection systems available in the market. It will be appreciated that similar software could also be developed and utilized by the applicant, or a third party.

The ANN software 24 has the ability to compare a large quantity of visual data, and over time and with increasing accuracy determine the following: whether a piece of equipment has been added or removed; whether the position of a piece of equipment has been changed; and whether the size of a piece of equipment has changed. If the ANN software 24 detects a change in the position of a piece of equipment, it will generate a unique alert notification 26. The host virtual machine 22 transfers the unique alert notification 26 over an internet network 28 to a guest virtual machine 30 using radio waves 15. The guest virtual machine 30 stores the unique alert notification 26 on a database 32. The unique alert notification 26 stored on the database 32 is then converted by the host virtual machine 22 into an alert message that can be displayed on a user interface 34, where the unique alert notification 26 is typically in an email format.

FIG. 2 illustrates an example cell tower 4 with an installed antenna 6 and base station 5. A camera 8 captures images of the base station 5, antenna 6 or another object (not shown) at regular intervals. The camera 8 has captured an image prior and accompanying visual data before and after a technician 35 adjusts the antenna for optimal performance. Both sets of captured images and accompanying visual data are transferred via optic fibre cables 10 to the edge server 12, and then to the specialized computer 14 via ethernet cables 11. The captured images and accompanying visual data are first transferred to the edge server 12, after which a whole set of stored captured images are analysed using an instance of ANN software 24 embedded on the edge server 12 in order to identify any differences in position and/or size of the base station 5, antenna 6 or another object (not shown). The captured images and accompanying visual data with identified differences are transferred via radio waves 15 to the intranet network 16.

The host virtual machine 22 and ANN software 24 is used for continuous development that is uploaded via radio waves 15 to the intranet network 16, and then to the edge server 12. The difference in position and/or size of the cellphone tower site 5, antenna 6 or another object (not shown) is identified and a unique alert notification 26 is transferred over the internet network 28, via radio waves 15, and received in an email format, which can then be displayed on a user interface 34. As seen in FIG. 2, the unique alert notification 26 displayed on the user interface 34 has an accompanying site code number 36 related to the cell phone tower 4, and the corresponding antenna unit that has been adjusted at a specific geographical location. In addition, the unique alert notification 26 also contains a unique ticket number 38 and time stamp 40 related to the detection of adjustment of a specific antenna 6.

1. A remote monitoring system, the system comprising:
a sensing arrangement for capturing visual data of an object;
an electronic database for storage of visual data;
a data transmission means for transmitting the visual data from the sensing arrangement to the electronic database; and
a method to identify physical and visual changes to the object,
wherein the method comprises the steps of receiving a first set of visual data of one or more objects, followed by receiving a second set of visual data of the one or more objects, and comparing the first and second set of visual data to identify visual and physical changes to the one or more objects.

2. The remote monitoring system according to claim 1, wherein the method is stored on the electronic database as an artificial neural network to learn how to identify differences between sets of visual data.

3. The remote monitoring system of claim 2, wherein the artificial neural network is detectron2 or PyTorch.

4. The remote monitoring system according to claim 1, wherein the electronic database generates a unique alert notification when any differences are detected between visual data.

5. The remote monitoring system according to claim 4, wherein the unique alert notification is transmitted to a remote computer by the data transmission means.

6. The remote monitoring system according to claim 5, wherein the unique alert notification contains a site code of the site where the object is geographically situated.

7. The remote monitoring system according to claim 1, wherein the data transmission means comprises any one or more of Bluetooth, radio wave, microwaves, fibre optics, local area network and/or wide area network.

8. The remote monitoring system according to claim 1, wherein the object is any one or more of an antenna, microwave dish and/or a base station.

9. The remote monitoring system according to claim 1, wherein the electronic database is hosted and accessed on one or more computers.

10. The remote monitoring system according to claim 1, wherein the sensing arrangement comprises at least one camera.

11. The remote monitoring system according to claim 1, wherein the visual data is transmitted by the data transmission means to a specialized computer and then transmitted by the data transmission means to the electronic database.

12. The remote monitoring system of claim 11, wherein the specialized computer is any one of a channel service unit, a data service unit and/or an intelligent remote site management device.

13. A method of monitoring changes made to one or more objects, comprising the steps of:
a) using a sensing arrangement to generate a first set of visual data of an object;
b) using the sensing arrangement to generate a second set of visual data of the object;
c) using data transmission means to transmit the first and second set of visual data to an electronic database;
d) using software stored on the electronic database to compare the first and second set of visual data to identify visual and physical changes to the object;
e) generating a unique alert notification when visual and physical changes are identified; and
f) transmitting the unique alert notification to a remote computer.
